(19) United States
(12) Patent Application Publication
(10) Pub. No.: US 2021/0010269 A1
(43) Pub. Date: Jan. 14, 2021

(54) ROOF REMOVAL DEVICE

(71) Applicant: Columbia Construction Services, Inc., Tualatin, OR (US)

(72) Inventors: Mark M. CARPENTER, Tigard, OR (US); Kacey M. CARPENTER, Newberg, OR (US); Jason A. PILLAR, Wilsonville, OR (US)

(73) Assignee: Columbia Construction Services, Inc., Tualatin, OR (US)

(21) Appl. No.: 16/927,820

(22) Filed: Jul. 13, 2020

Related U.S. Application Data
(60) Provisional application No. 62/873,065, filed on Jul. 11, 2019.

(51) Int. Cl. E04D 15/00; B02C 18/18; B02C 18/22

(52) U.S. Cl. CPC E04D 15/003; B02C 18/2216; B02C 18/18

(57) ABSTRACT

A roof removal machine may include an auger assembly at least a first helical auger flight coupled to a central axle, and a plurality of blades coupled to an outer edge of the auger flight. A motor is operably coupled to the auger assembly and configured to rotate the auger assembly about the axle in at least a first direction of rotation. The blade edge of each of the blades is oriented transverse to the first direction of rotation. In some examples, a second helical auger flight is also coupled to the central axle, and the two auger flights may be oppositely-handed with respect to each other, such that roof debris is moved toward a central extraction port.

### CROSS-REFERENCES

This application claims the benefit under 35 U.S.C. § 119(e) of the priority of U.S. Provisional Patent Application Ser. No. 62/873,065, filed Jun. 11, 2019, the entirety of which is hereby incorporated by reference for all purposes.

### FIELD

This disclosure relates to systems and methods for roof removal. More specifically, the disclosed embodiments relate to cutting systems for roof removal.

### INTRODUCTION

The tearing off an existing roof assembly is historically a dangerous and labor-intensive job. Typical reroofing processes require cutting the rooftop with a saw blade, mechanically scraping layers of roofing material from the rooftop, and moving the debris from the rooftop to a disposal area. Each step of the reroofing process may introduce worker safety risks and environmental hazards. Current reroofing processes use industrial saws and peelers, requiring manual material handling of debris which requires one or more workers to operate. The use of multiple machines and workers leads to high labor costs and exposes more workers to hazardous conditions.

Known cutting processes require slicing through layers of roofing material with a singular saw blade. These layers may include asphalt, fiber sheets, and insulation, all of which may include hazardous materials, mold, rot, or bacteria. Prolonged exposure to old roofing layers may expose workers to health risks. Existing scraping and material transport processes are physically demanding, leading to high staffing costs and requiring workers to repeatedly move heavy materials from the rooftop to the edge of the roof.

Existing reroofing processes also produce large pieces of roofing material in various sizes. This leads to inefficiency in transporting the material, once from the cutting area to the onsite debris container, then from the container to the offsite disposal area. Large cut sections of roofing are inefficient in how they stack or nest in the container and offsite disposal areas.

### SUMMARY

The present disclosure provides systems, apparatuses, and methods relating to roof removal. A system for unifying the cutting, scraping, and material movement processes would allow for increased efficiency and reduced risks to workers.

In some embodiments, a roof removal apparatus includes: a vehicle configured to travel across an underlying surface; and an auger assembly coupled to the vehicle, the auger assembly including a central axle defining an axis of rotation transverse to a direction of travel of the vehicle, a first helical auger flight having an inner edge coupled to the central axle, such that the first helical auger flight is rotatable about the axis of rotation, and a plurality of blades removably coupled to an outer edge of the first helical auger flight; wherein rotation of the first helical auger flight about the axis of rotation is configured to cause the plurality of blades to cut into the underlying surface.

In some embodiments, a roof removal machine includes: an auger assembly including a central axle defining an axis of rotation, a first helical auger flight coupled to the central axle, and a plurality of blades coupled to an outer edge of the first helical auger flight, each blade comprising a blade edge and a blade body; and a motor operably coupled to the auger assembly and configured to rotate the auger assembly about the axis of rotation in at least a first direction of rotation; wherein the blade edge of each of the blades is oriented transverse to the first direction of rotation.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a top plan view of a roof removal machine in accordance with aspects of the present disclosure.

FIG. 2 is a side elevation view of the roof removal machine of FIG. 1.

FIG. 3 is a front elevation view of an auger assembly for use with the roof removal machine of FIG. 1.

FIG. 4 is a bottom plan view of the auger assembly of FIG. 3.

FIG. 5 is an isometric view of an illustrative auger for use with the auger assembly of FIG. 3.

FIG. 6 is a front elevation view of the auger of FIG. 5.

FIG. 7 is an isometric view of the auger of FIG. 5 with the blades removed.

FIG. 8 is a front elevation view of the auger of FIG. 5 with the blades removed.

FIG. 9 is an isometric view of a blade for use with the auger assembly of FIG. 3.

FIG. 10 is a top plan view of a roof removal machine in accordance with aspects of the present disclosure.

FIG. 11 is a side elevation view of the roof removal machine of FIG. 10.

FIG. 12 is a top plan view of the roof removal machine of FIG. 10.

FIG. 13 is a side elevation view of the roof removal machine of FIG. 10.

FIG. 14 is a front elevation view of an auger assembly for use with the roof removal machine of FIG. 10.

FIG. 15 is a bottom plan view of the auger assembly of FIG. 14.

FIG. 16 is an isometric view of an illustrative auger for use with the auger assembly of FIG. 14.

FIG. 17 is a front elevation view of the illustrative auger of FIG. 16.

FIG. 18 is a top plan view of a blade for use with the auger assembly of FIG. 14.

FIG. 19 is an isometric view of the blade of FIG. 18

FIG. 20 is a front elevation view of the blade of FIG. 18.

FIG. 21 is a side elevation view of the blade of FIG. 18.

FIG. 22 is a bottom plan view of auger assembly in accordance with aspects of the present disclosure.

FIG. 23 is a side elevation view of the auger assembly of FIG. 22.

FIG. 24 is a flow chart depicting steps of a method in accordance with aspects of the present disclosure.

### DETAILED DESCRIPTION

Various aspects and examples of a roof removal system including an auger assembly and associated methods are described below and illustrated in the associated drawings. Unless otherwise specified, a roof removal system and/or auger assembly in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

The terms “inboard,” “outboard,” “forward,” “rearward,” and the like are intended to be understood in the context of a host vehicle on which systems described herein may be mounted or otherwise attached. For example, “outboard” may indicate a relative position that is laterally farther from the centerline of the vehicle, or a direction that is away from the vehicle centerline. Conversely, “inboard” may indicate a direction toward the centerline, or a relative position that is closer to the centerline. Similarly, “forward” means toward the front portion of the vehicle, and “rearward” means toward the rear of the vehicle. In the absence of a host vehicle, the same directional terms may be used as if the vehicle were present. For example, even when viewed in isolation, a device may have a “forward” edge, based on the fact that the device would be installed with the edge in question facing in the direction of the front portion of the host vehicle.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a roof removal device (AKA roof removal machine) in accordance with the present teachings includes an auger assembly having one or more helical flights coupled to a central axle (e.g., including a tube or sleeve) defining an axis of rotation. The auger further includes a plurality of blades removably coupled to the auger flights. Each blade (e.g., blade assembly) includes an arced portion (e.g., L- or J-shaped) and a blade body serving as a mounting bracket. Each blade is fastened to an auger flight. Rotating the auger about the axis of rotation causes the removal of layers of existing roofing material from a substantially horizontal and/or planar rooftop. The blade assemblies are configured to slice, peel, and mulch the roofing material, while the auger flights are configured to transport the material horizontally along the auger into the vacuum system.

The tube of the auger assembly may be configured to fit around and rotate with a coaxial central shaft or axle of the roof removal machine. In some examples, the tube is solid, functioning as both sleeve and axle. However, having a separate sleeve-like tube facilitates repair and replacement of portions of the auger assembly. The tube may comprise steel, aluminum, and/or any other suitable material. In some examples, the tube is configured to rotate around the axle, rather than with the axle as a single assembly.

The auger may include one or more helical flights, each flight including a single polygonal (e.g., rectangular) sheet of metal wrapped around the central tube in a helical fashion. The one or more helical flights are generally helicoid in nature, although geometrical variations are possible while maintaining the general functionality. Namely, the shape of the flights enable the auger to function as a horizontal screw conveyer, moving material away from the cutting area and toward an extraction port. As used herein, helical flights have chirality and can be described as either right-handed or left-handed. When viewed along the central axis, right-handed flights turned in a clockwise screwing motion would move the helix away from the observer. In contrast, a left-handed flight would move the helix toward the observer.

In some embodiments, the auger has two or more side-by-side helical flights (i.e., arranged in series along the central tube or axle). In some of these embodiments, at least one flight is left-handed and at least one flight is right-handed (i.e., the flights may be oppositely-handed), and the flights are arranged such that roofing material is directed toward a central extraction port. In some embodiments, the two flights are same-handed, effectively functioning as a longer single flight. In some embodiments, the auger includes a plurality of sectional flights, each comprising a polygonal sheet of metal. The flights may comprise any suitable material configured to be strong and durable, such as abrasion-resistant steel, carbon steel, stainless steel, aluminum, nickel alloys, and/or the like. The flights may be attached to the tube by brazing, welding, soldering, and/or any other suitable method for bonding two metals. Alternatively or additionally, the flights may be removably coupled to the central tube using removable fasteners, such as screws, pins, rivets, and/or the like. In some examples, one or more blade assemblies are removably coupled to the flight(s), and each flight may include attachment points (e.g., including holes configured to receive removable fasteners for this purpose).

The extraction port is included within a blade housing coupled to the auger assembly. In single-flighted embodiments of the auger assembly, the extraction port may be disposed at an outboard end portion of the blade housing. In multi-flighted embodiments of the auger assembly, the extraction port may be disposed at a central location on the blade housing, e,g., at a transverse midpoint of the blade housing. The auger is configured to move roofing material along the auger so as to break up or mulch the material into smaller pieces, thereby facilitating efficient disposal.

The auger assembly further includes a plurality of blades fixed to the auger flights at peripheral edges, such that rotating the auger assembly along the rooftop causes the blades to cut through the rooftop. In some examples, the blades include a blade body coupled to a mounting bracket, and the auger flights are received between blocks of the mounting bracket. In some embodiments, the blade bodies are bolted or otherwise removably fastened directly to the auger flights. The blades may be configured to be easily replaced, e.g., for replacing damaged blades and to extend the life of the auger assembly. For example, the blades may wear more quickly than the auger flights and therefore need more frequent replacement. In some embodiments, the blades are permanently coupled to the auger flights, e.g., by welding, soldering, or brazing. The blades are arranged and spaced apart along the auger flights, such that the blades impact overlapping areas of the roof. In some embodiments, blade assemblies are spaced such that each blade assembly is separated from adjacent blade assemblies by a separation angle of 90°. In these embodiments, blade assemblies align to form one or more colinear cutting edges, separated by 90° angles (i.e., at 90° intervals). In some embodiments, blade assemblies are separated by angles/intervals of 30°, 45°, 60°, 120°, 180°, or any other suitable angle for ensuring complete roof coverage. In some embodiments, blade assemblies may not align to form colinear cutting edges.

In some examples, the blade body includes a blade tip and a blade support disposed transverse (e.g., perpendicular) to each other, such that the blade body has an L-shaped profile. The blade tip may be any suitable shape (e.g., rectangular, or trapezoidal), and tipped with a blunt or sharpened blade edge.

In some examples, the blade support includes a bisecting slot, wherein the slot is configured to receive an edge of one of the auger flights. The blade body may comprise any suitable material configured to be durable and strong, such as abrasion-resistant steel, carbon steel, stainless steel, aluminum, nickel alloys, and/or the like. The blade body may include a blade edge comprising a different material, such as carbide, and/or another durable alloy brazed, welded, soldered, or otherwise attached to the blade tip.

In some examples, the mounting bracket reinforces the blade body, and may include a pair of blocks coupled to the blade body on either side of the slot. The blocks are orthogonal to both the blade tip and the blade support, such that first lateral edges are in contact with the blade tip and second lateral edges are in contact with the blade support. The bracket may comprise any suitable material configured to be durable and structural, e.g., abrasion-resistant steel, carbon steel, stainless steel, aluminum, nickel alloys, and/or the like. The bracket may be attached to the blade body using brazing, welding, soldering, and/or any other suitable method for attaching two metals. The bracket blocks each include one or more apertures or openings for fasteners, configured to receive screws, bolts, pins, or other suitable fasteners as described further below.

Accordingly, mounting the blade assembly to one of the auger flights includes sliding the blade assembly onto the auger flight such that the auger flight is received by the slot and contacted on each side by a bracket support block. Each blade assembly may be secured to the auger flight using screws, pins, or other fasteners inserted through the bracket and auger flight.

In operation, the blade assembly has a slicing edge disposed at a distal end, which cuts into the rooftop as the auger is rotated about the axis of rotation. As the auger is rotated, the slicing edge slides beneath the roofing layers, exerting upward pressure on a lower surface of the roofing materials. The rotation of the auger slides the slicing edge along the roof decking surface, peeling and chopping the roofing layers from the decking. As the roofing layers are peeled, they are broken into smaller pieces (AKA mulched) against the bracket.

The auger assembly may remove a selected thickness (e.g., up to 6″) of combined roofing layers, depending on a radial dimension of the flights and a length of the blade assemblies. In some examples, the auger assembly is rotated in a first direction, wherein the blades cut the roofing material at an obtuse angle with respect to the surface of the rooftop. In some examples, the auger assembly is rotated in a second direction, wherein the blades cut the roofing material at an acute angle with respect to the rooftop. The direction of rotation may be changed with a control system, e.g., to aid in the clearing of any obstructions introduced during the roof removal process.

In general, a roof removal machine including the auger assembly disclosed herein has a removable auger assembly, a blade housing, a motor, and a control system. The removable auger is vertically translatable so that it is capable of removing, e.g., up to 6″ of roof in a single pass.

The blade housing may cover the top and front edges of the auger, thereby protecting a user from any debris that may be expelled during the roof removal process. The blade housing may further include a blade guard and an extraction port. In some examples, the blade housing aids in the operation of a vacuum debris extraction process, e.g., by reducing loss of airflow adjacent the extraction port. A breaker bar may be located at the front of the blade guard, e.g., at 270 to 300 degrees from top of blade. The breaker bar is affixed to the guard, and may leave a gap (e.g., ¾ inch) between the blade and the breaker bar plane edge to pinch, fracture, and slice the roofing material further before it proceeds into the extraction port. The blade guard may have a curved top guard panel, and first and second containment panels disposed on lateral sides of the top guard panel, such that roofing material removed by the auger assembly may only exit the blade guard from the extraction port.

The first and second guard side panels may comprise chain-link or woven fencing, mesh, and/or any other suitable semi-porous, durable barrier material configured to contain removed roofing material. The top guard panel may include an extraction port disposed centrally, or at either lateral edge, and adjacent a lower rear edge of the top guard panel. The rear edge is configured to contact an underlying surface (i.e., the surface of the roof decking). The extraction port may include an aperture (e.g., a round or rectangular hole) coupled to a protruding nozzle or funnel. The curved top guard panel of the blade guard may have one or more shearing or scraping edges disposed at a lower front edge configured to contact the underlying surface. The shearing edge may comprise abrasion-resistant steel, carbon steel, stainless steel, aluminum, nickel alloys, or any durable metallic material. The shearing edge may be disposed higher than the rear edge of the guard panel by an offset distance (AKA height differential) (e.g., 6 inches), such that the auger assembly cuts into the roofing material by an amount no deeper than the offset distance. In other words, the resulting height differential corresponds to a selected cutting depth. This may prevent the auger assembly from cutting into underlying decking of the roof by ensuring a maximum cutting depth. The shearing edge may also scrape a top surface of the roofing material, removing fasteners or uneven pieces of roofing material.

The bottom, roof-contacting portion of the auger assembly (e.g., the bottom of the blade guard) may include feet (AKA runners) configured, in part, to define a maximum cutting depth. The feet contact and ride on the underlying roof surface, and keep the blades at a selected offset height. In other words, the feet are configured to ensure the blades do not come in contact with the roof deck or penetrate into the cutting material further than expected or desired. This height may be adjustable, e.g., using the angle at which the blade guard is assembled to the guard mounting bracket. In some examples, the blade guard may have articulating portions that enable the feet to move in a generally upwards and/or downwards direction to maintain a consistent cutting depth on uneven roof decking.

Additionally, the feet are configured to enable the auger assembly to easily move across the roof deck. For example, if the roof deck is uneven, the feet may glide over the uneven surface to smoothly transition the auger assembly along the roof deck surface.

The blade housing and auger assembly may be mounted at the rear of the roof removal machine. The roofing machine may further include a machine body and a plurality of wheels. In some embodiments, the roofing machine includes two wheels disposed at the front of the roofing machine and two wheels disposed directly in front of the blade housing and auger assembly. The control system may be disposed above and slightly behind the blade housing and auger assembly.

The motor may be gas, electric, a hybrid gas and electric motor, and/or any other suitable prime mover. In some embodiments, the motor is disposed at the front of the roof removal machine. The motor may power a series of auger adjustment systems, including wheels, a height adjustment system, and an auger assembly motor for rotation of the auger assembly. In some embodiments these systems are hydraulic, but may additionally or alternatively be pneumatic, electric, mechanical, or any other suitable automatic, semiautomatic, or manual adjustment systems.

The control system is configured to direct the motion of the machine and of the auger assembly. In some embodiments, these controls may be hydraulic. The control system may include a directional control system to controls the steering of the roof removal machine. The control system may further include an auger assembly height control system, which may raise and lower the auger assembly, controlling cutting depth. The control system may further include an auger motor control system, which may control the speed and direction of rotation of the auger assembly.

The roof removal machine may further include a debris extraction system for disposal of mulched roofing material. The extraction system is configured to couple to the extraction port of the blade housing. The extraction system may move material from a cutting area to a disposal area. The disposal area may include an area on the rooftop or a surface or container disposed adjacent to the rooftop. In some embodiments, the extraction system includes an air pump or vacuum pump configured to move material through the extraction system. In these embodiments, the extraction system further comprises a vacuum extraction tube coupled to the extraction port. Once the material has been extracted from the blade system it is handled through the extraction system (e.g., using a hose and/or pipe) until it is released, e.g., into a final receptacle on the ground level. In some examples, the extraction system may include a dust collection system (e.g., an abrasion resistant mobile dust collector) or another suitable filtration system disposed at a selected location between the extraction port and the final receptacle.

In general, a method for removing layers of roofing material from an underlying roof decking includes adjusting the height of the auger assembly, rotating the auger assembly, and translating the auger assembly along the roof decking.

### Examples, Components, and Alternatives

The following sections describe selected aspects of illustrative roof removal systems and auger assemblies as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. First Illustrative Roof Removal Machine

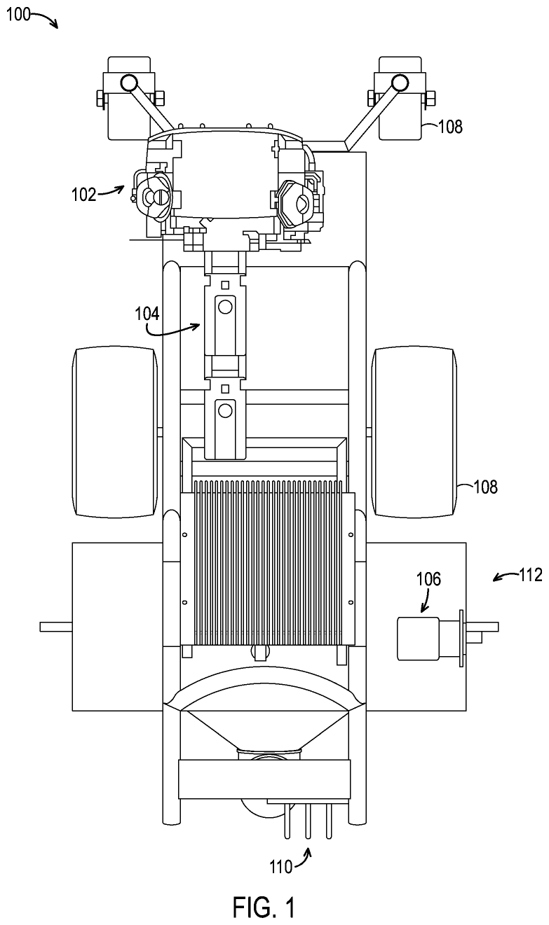

As shown in FIGS. 1-9, this section describes an illustrative roof removal machine 100. Roof removal machine 100 is an example of the roof removal machine described above.

As shown in FIG. 1, roof removal machine 100 including a motor 102, a hydraulic pump 104, one or more hydraulic system motors 106, two or more wheels 108, a control system 110, an auger assembly 112, and an extraction port 114 disposed at a rear of auger assembly 112.

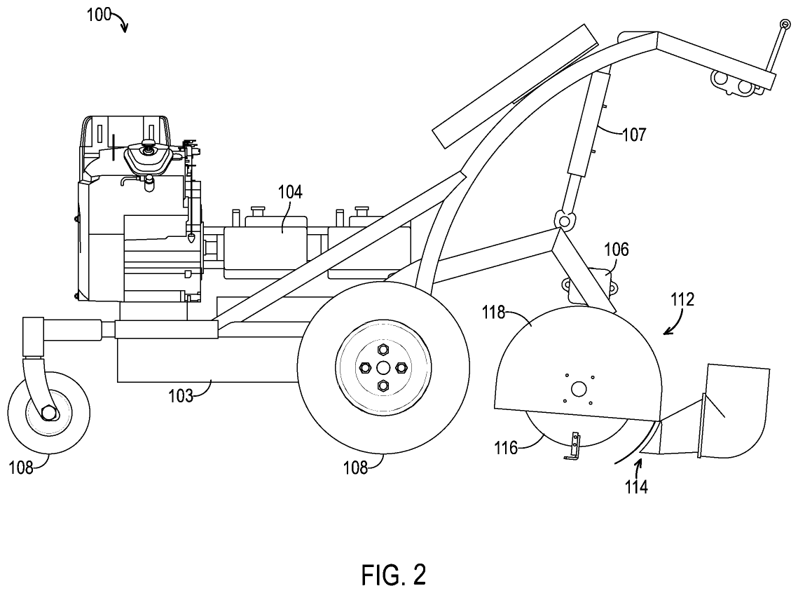

As shown in FIG. 2, auger assembly 112 includes a removable auger 116, which is an example of the augers described more generally above. Roof removal machine 100 powers a rotation of auger 116, which impacts layers of roofing material disposed beneath the roof removal machine. Auger assembly 112 additionally includes a blade housing 118 configured to provide safety guarding and to contain and direct removed roofing material, ensuring an operator of the machine may safely operate the roof removal machine. In some embodiments, roof removal machine 100 includes an extraction system (not pictured) coupled to extraction port 114, which moves the removed roofing material from a rooftop to an underlying surface or receptacle below the rooftop.

Auger assembly 112 is configured to be mounted at the rear of the roof removal machine 100, as shown in FIG. 2, although other configurations may be utilized, such as front-mounting or side-mounting. In some embodiments, the roofing machine includes two wheels 108 disposed at the front of the roofing machine and two wheels 108 disposed directly in front of the blade housing and auger assembly. The control system 110 may be disposed above and slightly behind the blade housing and auger assembly, such that an operator of the roof removal machine may walk behind the roof removal machine while operating the control system. The control system 110 may include a stem or appendage that may allow for steering of the machine.

The roof removal machine may include one or more motors or engines 102 for powering the machine. The motors or engines may be any suitable prime mover (e.g., gas powered internal combustion engines and/or electric motors). In some embodiments, the motor is disposed at the front of the roof removal machine. The motor may power a series of auger adjustment systems, which may be configured to control machine movement, auger position and rotation, and/or any suitable alternative control system. These systems may be pneumatic, electric, mechanical, and/or any other suitable automatic, semiautomatic, or manual adjustment systems.

In some embodiments, roof removal machine 100 includes a hydraulic system comprising: one or more tanks 103 for storing hydraulic fluid, a pump 105, hydraulic system motor 106, and a hydraulic cylinder 107. The hydraulic cylinder 107 may translate and/or selectively transition the auger assembly 112 between a plurality of heights, thereby controlling the cutting depth of the auger assembly. In some embodiments, the hydraulic system powers the wheels 108. In some embodiments, the roof removal machine includes two powered rear wheels and two front wheels for steering.

Control system 110 is configured to direct the motion, speed, and direction of the machine and of the auger assembly. Interactive controls of control system 110 may include any suitable systems for adjustment of the roofing machine, such as levers, valves, switches, toggles, and/or the like. The controls may include a first valve for directional control of the machine. The first valve may control the steering of the machine by rotating the front wheels. The controls may further include a toggle control valve stem for the raising and lowering of auger assembly 112, e.g., by hydraulic cylinder 107. Depending on the valve arrangement, the toggle may cause different results based on different toggle directions. For example, pushing the toggle forward may raise the hydraulic cylinder, thereby raising the auger assembly; pulling the toggle rearward may lower the hydraulic cylinder, thereby lowering the auger assembly. In some examples, the forward/rearward directions of the toggle are reversed, and other directions may be used instead (e.g., left/right). In some examples, the control system may include a valve stem for activating the rotation of the auger. The valve stem may be transitionable between an off position, position corresponding to a first direction of rotation, and a position corresponding to a second direction of rotation.

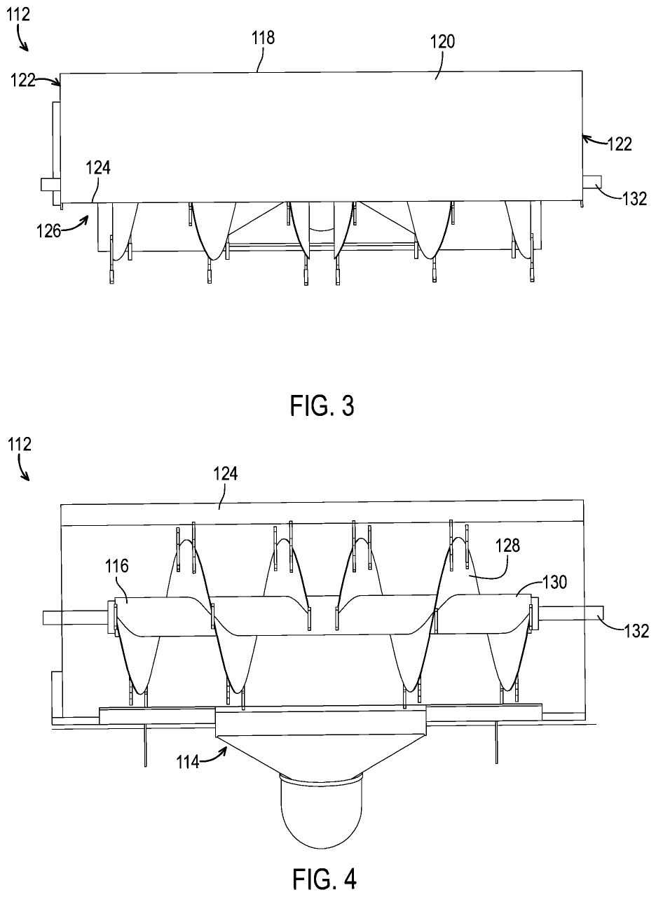

FIGS. 3 and 4 depict auger assembly 112. Blade housing 118 at least partially encloses the top, front, and sides of the auger assembly 112, which may protect a user of the auger assembly from the rotating blades and any debris that may be expelled during the roof removal process. As shown in FIG. 4, blade housing 118 is coupled to extraction port 114. As mentioned above, the blade housing may further function as an aid to vacuum extraction via the extraction port, e.g., by reducing loss of airflow and/or focusing the vacuum effect.

Blade housing 118 includes a curved top guard panel 120 and first and second containment panels 122. Curved top guard panel 120 may resemble half of a metal tube or cylinder. The first and second containment panels 122 may comprise any suitable material, such as chain-link or woven fencing, mesh, or any semi-porous durable barrier material configured to ensure that roofing material removed by the removable auger assembly is contained by the blade housing. The curved guard panel 120 is coupled to extraction port 114 disposed at a center location on the guard panel and adjacent a rear edge of the guard panel. Extraction port 114 may include an aperture coupled to a protruding nozzle or funnel. Blade housing 118 may additionally comprise a shearing edge or scraping edge 124 disposed at a front edge of the guard piece.

Edge 124 may comprise any metallic material configured to be strong and durable, such as abrasion-resistant steel, carbon steel, stainless steel, aluminum, nickel alloys, or the like. In some examples, edge 124 is disposed higher than the rear edge of the guard panel by an offset distance 126 (e.g., 6″), such that the auger assembly cuts into the roofing material by an amount no deeper than the offset distance. This configuration of blade housing 118 may prevent the auger assembly from cutting into underlying decking of the roof by ensuring a maximum cutting depth. The shearing edge is configured to scrape a top surface of the roofing material, e.g., removing fasteners or uneven pieces of roofing material. Offset distance 126 may be adjustable, e.g., by repositioning or rotating the blade guard to increase or decrease the vertical distance between edge 124 and the rear edge of blade housing 118.

Removable auger 116 includes one or more auger flights 128 coupled to a central tube or sleeve 130. Auger flight(s) 128 wrap around central tube 130 in a helical fashion. Auger flights 128 may be coupled to central tube 130 using any suitable method for attaching two metal objects to each other, such as welding, soldering, brazing, fastening, and/or the like. Central tube 130 may be configured to receive a central shaft or axle 132 coaxially, and to either be fixed to the axle or to rotate thereon. In some examples, central tube 130 is keyed, screwed, and/or otherwise mechanically secured to axle 132. Central tube 130 defines an axis of rotation 134 about which removable auger 116 is configured to rotate. Central tube 130 may comprise steel, aluminum, and/or any material suitable for supporting auger flights 128.

Auger flights 128 may comprise one or more curved (e.g., polygonal, rectangular, etc.) sheets of any suitable material configured to be strong and durable, such as abrasion-resistant steel, carbon steel, stainless steel, aluminum, nickel alloys, and/or the like. In the present embodiments, auger 116 includes two auger flights 128A and 128B. In the present example, auger flight 128A is right-handed and auger flight 128B is left-handed. In this manner, rotating auger 116 displaces removed roofing material toward the center of the auger assembly.

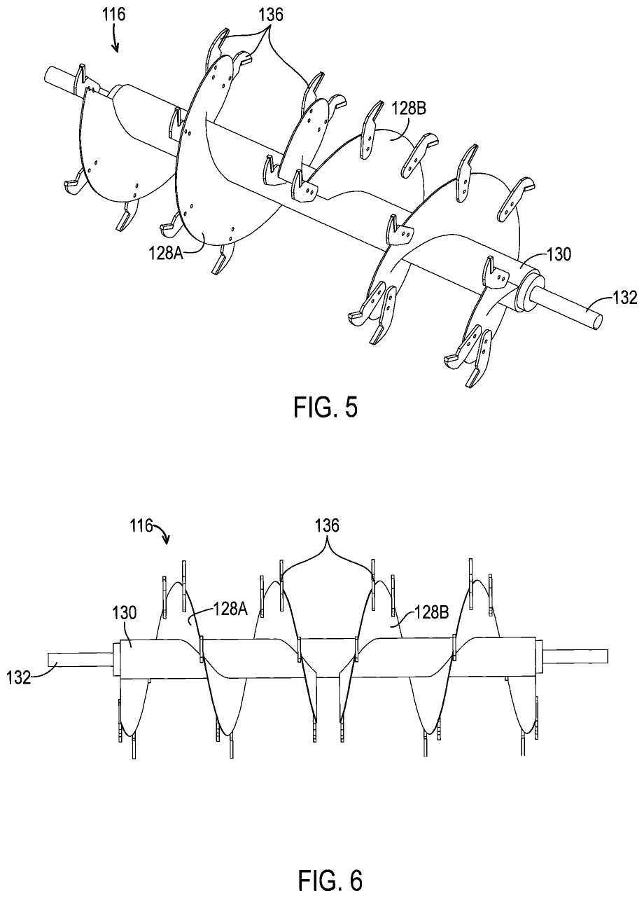

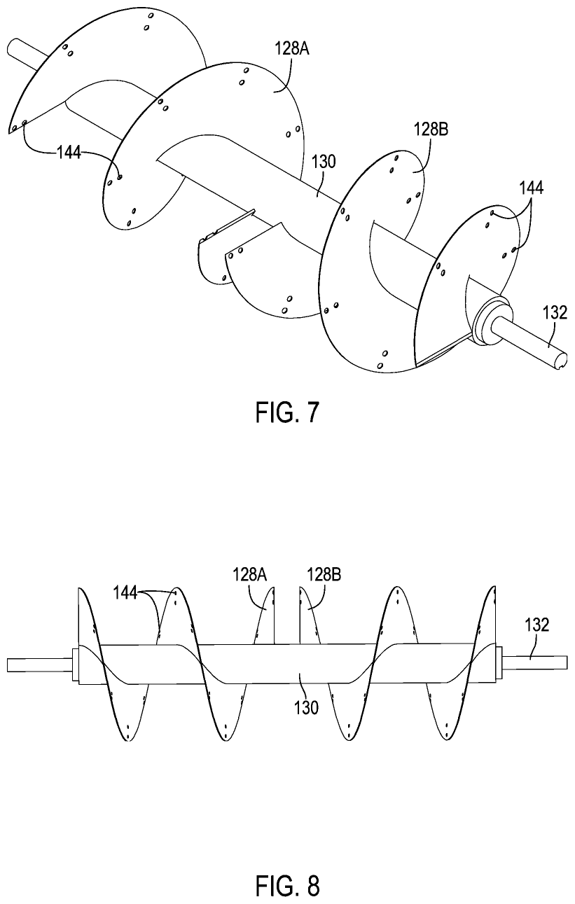

As shown in FIGS. 5 and 6, auger 116 further includes a plurality of blades 136, removably coupled to edges of auger flights 128. Each blade 136 includes a blade body 138 and a blade tip 140 (also referred to as a distal end of the blade, and/or a blade end portion). In some embodiments, blades 136 may include one or more fastener holes 142 configured to receive fasteners (e.g., screws, pins, etc.). Auger flights 128 may include complimentary holes 144 (see FIGS. 7 and 8) configured to receive the fasteners similarly received within fastener holes 142 of blade body 138. In some embodiments, blades 136 may be permanently coupled to auger flights 128, e.g., by welding, soldering, or brazing. Blades 136 are arranged and spaced out along outer edges of the auger flights such that they impact overlapping areas of the roofing material in response to rotation of auger 116.

In some embodiments, the blades are spaced such that each blade is separated from adjacent blades by a separation angle of 90°. In these embodiments, multiple blades 136 align to form one or more colinear cutting edges, separated by 90° angles. In some embodiments, the blades are separated by angles of 30°, 45°, 60°, 120°, 180°, or any other suitable angle for ensuring complete roof coverage. In some embodiments, the blades may not align to form colinear cutting edges.

Mounting one blade 136 to one auger flight 128 may comprise placing the blade assembly onto peripheral edges of the auger flight such that holes 142 and holes 144 are substantially aligned. Each blade 136 may be fastened to the auger flight 128 using the fasteners inserted through the fastener holes 142 and 144 of the blade body and auger flight.

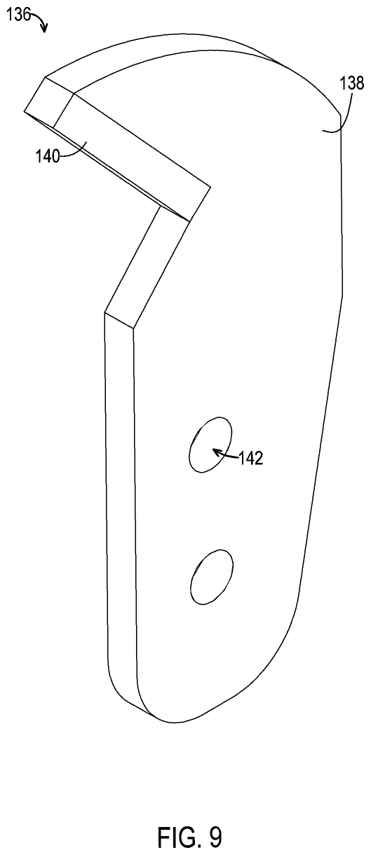

FIG. 9 depicts an individual blade 136. Each blade 136 is configured to be coupled to an edge of one of auger flights 128, as described above. Blade tip 140 may be any suitable shape (e.g., rectangular or trapezoidal) and includes a blunt or sharpened blade edge. As depicted in FIG. 9, blade 136 has a curved profile with a varying radius. For example, the back of blade 136 may have a decreasing radius of curvature as the tip is approached, such that the distal end portion of the blade has an r-shaped or J-shaped profile. In other words, blade 136 has a curvilinear back profile, with a back edge that is more sharply curved toward the tip. This configuration enables the primary cutting edge of blade tip 140 to slice and/or peel the roofing material, while preventing undesired contact between the back edge of blade 136 and the roof decking.

In some examples, blade tip 140 may be non-removably attached to blade body 138, e.g., using any suitable method for bonding two metals or metal alloys, such as brazing, welding, soldering, and/or the like. In some examples, blade tip 140 may be unitary with blade body 138. Blade body 138 comprises any material configured to be durable and strong, such as abrasion-resistant steel, carbon steel, stainless steel, aluminum, nickel alloys, and/or the like. In some examples, blade edge 140 comprises a different material, such as Tantung, carbide, and/or another durable alloy. The alloy forming blade tip 140 is selected based on durability and strength of the cutting edge of blade 136. The alloy or metal forming blade body 138 is selected to provide strength and durability, but may comprise a more affordable material than the alloy selected for blade tip 140.

### B. Second Illustrative Roof Removal Machine

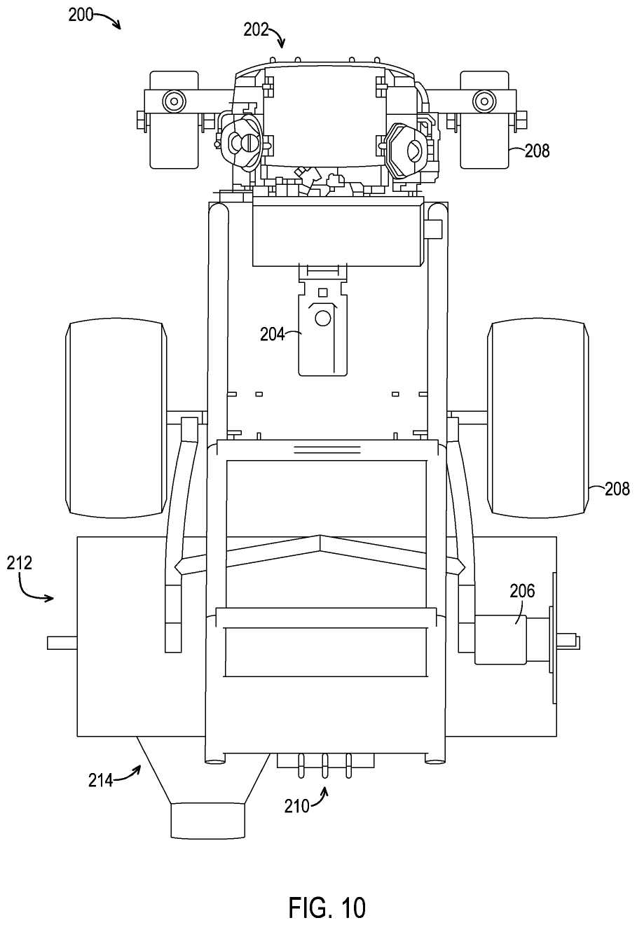

As shown in FIGS. 10-21, this section describes an illustrative roof removal machine 200 according to the present disclosure. Roof removal machine 200 is an example of the roof removal machine described above.

As shown in FIG. 10, roof removal machine 200 including a motor 202, a hydraulic pump 204, one or more hydraulic motors 206, two or more wheels 208, a control system 210, an auger assembly 212, and an extraction port 214 disposed at a rear edge of auger assembly 212.

Auger assembly 212 is configured to be mounted at the rear of the roof removal machine 200, as shown in FIG. 10-13, although other configurations may be utilized, such as front-mounting or side-mounting. In some embodiments, the roofing machine includes two wheels 208 disposed at the front of the roofing machine and two wheels 208 disposed directly in front of the blade housing and auger assembly. The control system 210 may be disposed above and slightly behind the blade housing and auger assembly, such that an operator of the roof removal machine may walk behind the roof removal machine while operating the control system. The control system 210 may be coupled to the roof removal machine 200 by a stem or appendage that may allow for steering of the machine.

Auger assembly 212 includes a removable auger 216, which is an example of the augers described more generally above. Roof removal machine 200 powers a rotation of auger 216, which impacts layers of roofing material disposed beneath the roof removal machine.

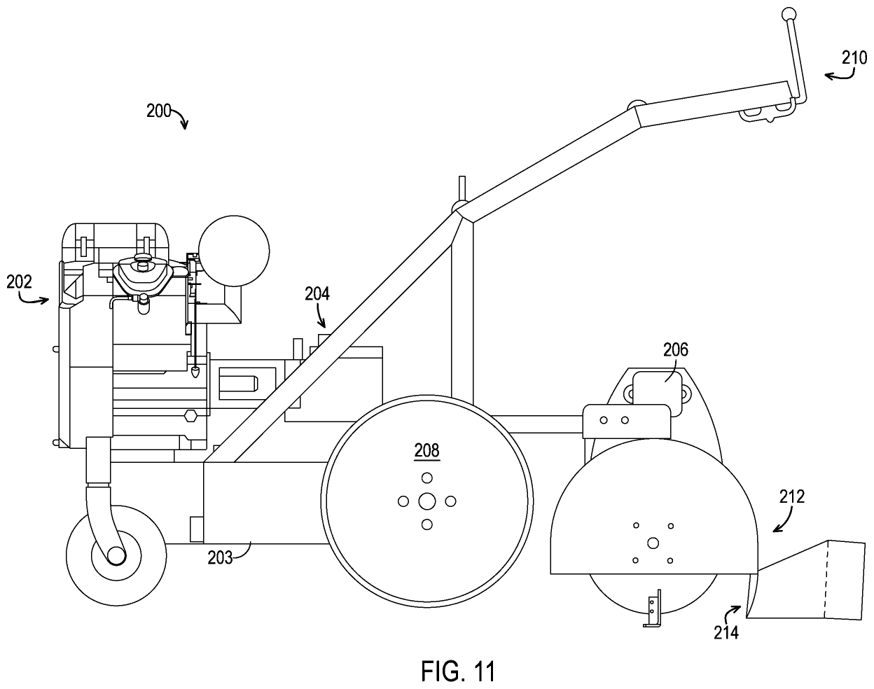

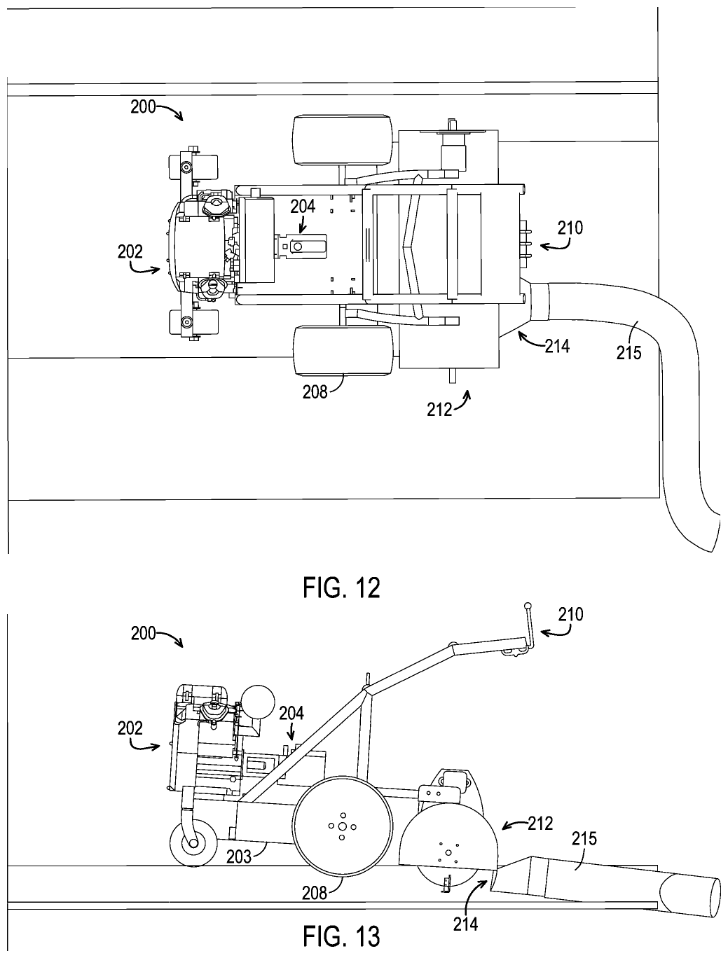

Auger assembly 212 includes a blade housing 218 configured to provide safety guarding and to contain and direct removed roofing material, ensuring an operator of the machine may safely operate the roof removal machine. In some embodiments, roof removal machine 200 includes an extraction system 215 (see FIGS. 12 and 13) coupled to extraction port 214, which moves the removed roofing material from a rooftop to an underlying surface or receptacle below the rooftop.

The roof removal machine may include one or more motors or engines 202 for powering the machine. The motor(s) 202 may be any suitable prime mover (e.g., gas powered engine, electric motor, etc.). In some embodiments, the motor is disposed at the front of the roof removal machine. The motor may power a series of auger adjustment systems, which may be configured to control machine movement, auger position and rotation, and/or any suitable alternative control system. These systems may be pneumatic, electric, mechanical, and/or any other suitable automatic, semiautomatic, or manual adjustment systems.

In some embodiments, roof removal machine includes a hydraulic system comprising: one or more tanks 203 for storing hydraulic fluid, a pump 205, hydraulic motor 206, and a hydraulic cylinder. The hydraulic system is configured to translate and/or selectively transition the auger assembly 212 between a plurality of heights, thereby controlling the cutting depth of the auger assembly. In some embodiments, the hydraulic system may power the wheels 208. In some embodiments, the roof removal machine may include two powered rear wheels and two front wheels for steering.

Control system 210 is configured to direct the motion, speed and direction of the machine and of the auger assembly. Interactive controls of control system 110 may include any suitable systems for adjustment of the roofing machine, such as levers, valves, switches, toggles, and/or the like. The controls may include a first valve for directional control of the machine. The first valve may control the steering of the machine by rotating the front wheels. The controls may further include a toggle control valve stem for the raising and lowering of the auger assembly 212, e.g., by the hydraulic system. For example, pushing the toggle forward may raise the hydraulic cylinder, thereby raising the auger assembly; pulling the toggle rearward may lower the hydraulic cylinder, thereby lowering the auger assembly. In some examples, the control system may include a valve stem for activating the rotation of the auger. The valve stem may be transitionable between an off position, position corresponding to a first direction of rotation, and a position corresponding to a second direction of rotation.

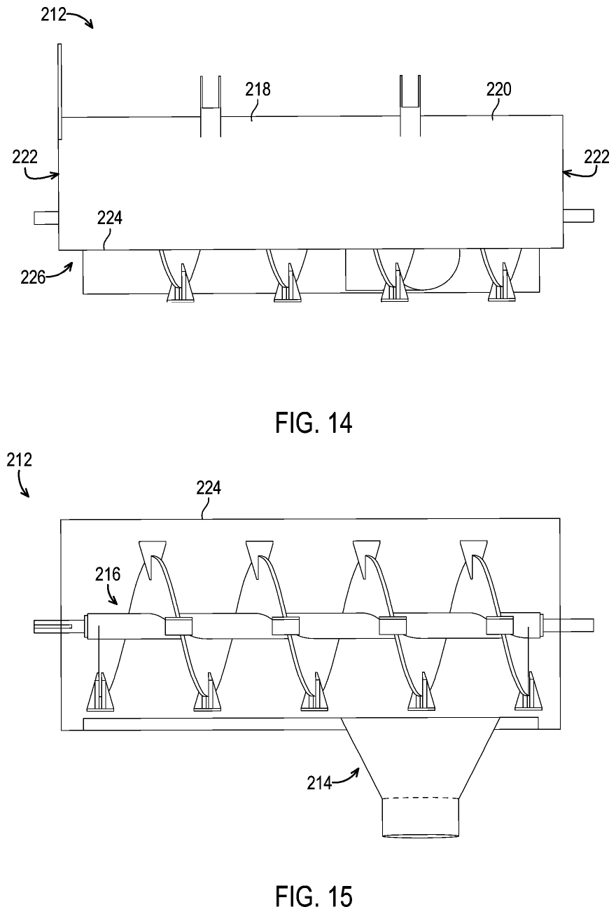

FIGS. 14 and 15 depict auger assembly 212. Blade housing 218 at least partially encloses the top, front, and sides of the auger assembly 212, which may protect a user of the auger assembly from any debris that may be expelled during the roof removal process. As shown in FIG. 15, blade housing 218 is coupled to extraction port 214.

Blade housing 218 includes a curved top guard panel 220 and first and second containment panels 222. The curved top guard panel 220 may resemble half of a metal tube or cylinder. The first and second containment panels 222 may comprise chain-link or woven fencing, mesh, or any semi-porous durable barrier material configured to ensure that roofing material removed by the removable auger assembly is contained by the blade housing. The curved guard panel 220 is coupled to extraction port 214 adjacent a rear edge of the guard panel. Extraction port 214 may include a round aperture coupled to a protruding nozzle or funnel. Blade housing 218 may additionally comprise a shearing edge or scraping edge 224 disposed at a front edge of the guard piece.

Edge 224 may comprise any metallic material configured to be strong and durable, such as abrasion-resistant steel, carbon steel, stainless steel, aluminum, nickel alloys, or the like. In some examples, edge 224 may be disposed higher than the rear edge of the guard panel by an offset distance 226 (e.g., 6″), such that the auger assembly may cut into the roofing material by an amount no deeper than the offset distance. This configuration of blade guard may prevent the auger assembly from cutting into underlying decking of the roof by ensuring a maximum cutting depth. The shearing edge is configured to scrape a top surface of the roofing material, removing fasteners or uneven pieces of roofing material. The offset distance 226 may be adjustable by repositioning or rotating the blade guard to increase or decrease the vertical distance between edge 224 and the rear edge of blade housing 218.

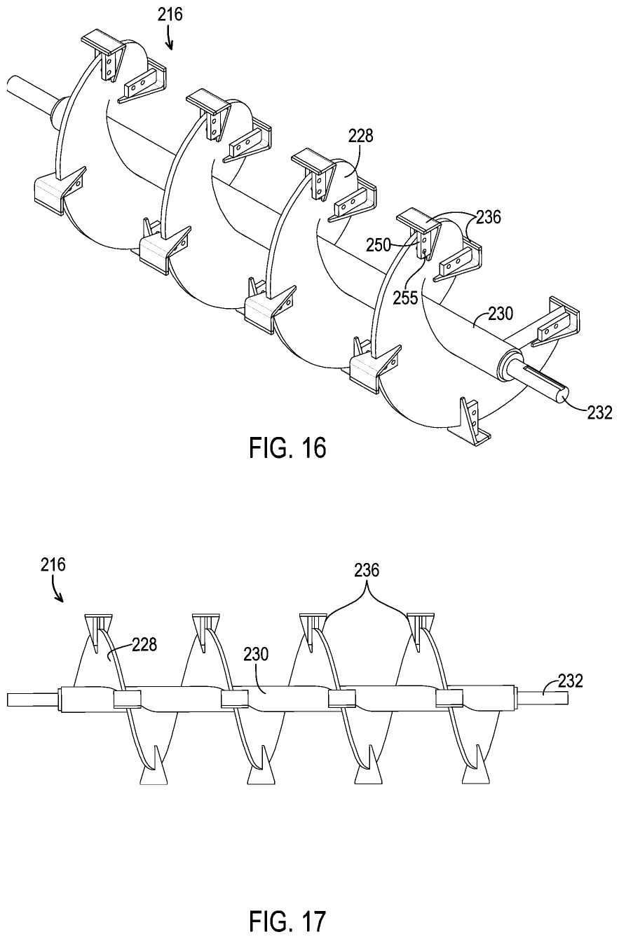

FIGS. 16 and 17 depict removable auger 216. Removable auger 216 includes one or more auger flights 228 coupled to a central tube or sleeve 230. Auger flight(s) 228 wrap around central tube 230 in a helical fashion. Auger flight(s) 228 may be coupled to central tube 230 using any suitable method for attaching two metals, such as welding, soldering, brazing, and/or the like. Central tube 230 may be configured to coaxially receive a central shaft or axle 232. Central tube 230 may be keyed, screwed, and/or otherwise mechanically secured to shaft or axle 232. Central tube 230 defines an axis of rotation 234 about which auger 216 is configured to rotate. Central tube 230 may comprise steel, aluminum, and/or any material suitable for supporting auger flight 228.

Auger flight 228 comprises one or more curved (e.g., polygonal, rectangular, etc.) sheets of any suitable material configured to be strong and durable, such as abrasion-resistant steel, carbon steel, stainless steel, aluminum, nickel alloys, and/or the like. In the current example, auger 216 includes a single auger flight 228 extending the length of the central tube. In some examples, auger 216 include two auger flights configured to wrap around the central tube in opposing directions. Rotating the auger thereby displaces removed roofing material toward extraction port 214.

As shown in FIGS. 16 and 17, auger 216 further includes a plurality of blades or blade assemblies 236, removably coupled to edges of auger flights 228. Each blade 236 includes an arced blade body 238 coupled to a mounting bracket 250. In some embodiments, blades 236 may include one or more fastener holes 255 configured to receive fasteners (e.g., screws, pins, etc.). Auger flight 228 may include similar holes configured to receive fasteners received within fastener holes 255 of mounting brackets 250. In some embodiments, blade assemblies 236 may be permanently coupled to auger flights 228, e.g. by welding, soldering, or brazing.

Blades 236 are arranged and spaced out along outer edges of the auger flights such that they impact overlapping areas of the roofing material in response to rotation of auger 216. In some embodiments, blade assemblies are spaced such that each blade assembly is separated from adjacent blade assemblies by a separation angle of 90°, when viewed from a viewpoint perpendicular to the axis of rotation of the auger assembly. In these embodiments, blade assemblies align to form one or more colinear cutting edges, separated by 90° angles. In some embodiments, blade assemblies are separated by angles of 30°, 45°, 60°, 120°, 180°, or any other suitable angle for ensuring complete roof coverage. In some embodiments, blade assemblies may not align to form colinear cutting edges.

Mounting one blade 236 to one auger flight 228 may comprise sliding the blade assembly onto peripheral edges of the auger flight such that the auger flight is contacted on each side by mounting brackets 250 and fastener holes 255 substantially align with the holes in auger flight 228 (see FIGS. 16 and 17). Each blade assembly 236 may be fastened to the auger flight 228 using screws, pins, or other fasteners inserted through the fastener holes 255 of bracket 250 and associated holes of the auger flight.

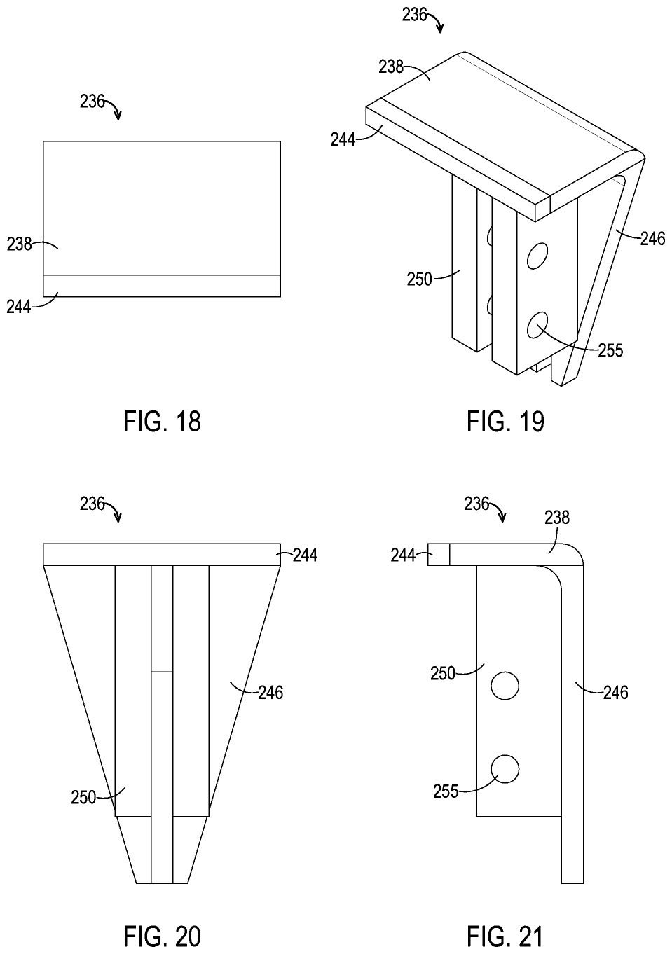

FIGS. 18-21 depict various views of blades 236. Each blade 236 is configured to be coupled to an edge of one of auger flights 228. Each blade 236 includes a blade body 238 and a blade support 246, each coupled to mounting bracket 250. Blade body 238 and blade support 246 are disposed transverse to each other such that each blade 236 is roughly L-shaped. Blade support 246 may be substantially triangular, trapezoidal, or rectangular in shape. Coupled to a distal end of blade body 238 is a blade tip 244. Blade tip 244 may be any suitable shape (e.g. rectangular or trapezoidal) and tipped with a blunt or sharpened edge.

FIG. 18 shows a top plan view of one of blades 236. FIG. 19 depicts blade tip 244 attached to blade body 238, e.g., using any suitable method for bonding two metals or metal alloys, such as brazing, welding, soldering, and/or the like. Blade body 238 may comprise any material configured to be durable and strong, such as abrasion-resistant steel, carbon steel, stainless steel, aluminum, nickel alloys, and/or the like. Blade tip 244 may comprise a different material, such as Tantung, carbide, and/or another durable alloy.

FIG. 19 and FIG. 20 show an isometric view and a front elevation view of one of blades 236, demonstrating blade support 246 disposed transverse to blade body 238. In some embodiments, blade body 238 and blade support 246 are oriented perpendicular to each other (e.g. at a 90° angle). In some embodiments, blade body 238 and blade support 246 are disposed at another suitable angle for cutting layers of roofing material, such as 60°, 75°, 120°, and/or any angle which enables the blade to cut into the roofing material.

Blade support 246 may comprise any material configured to be durable and strong, such as abrasion-resistant steel, carbon steel, stainless steel, aluminum, nickel alloys, and/or the like. In some embodiments, blade body 238 and blade support 246 are formed as a single piece.

Bracket 250 is configured to have a suitable shape for contacting both blade body 238 and blade support 246, for example rectangular, triangular, or another suitable polygonal shape. Bracket 250 may comprise any material configured to be durable and strong, such as abrasion-resistant steel, carbon steel, stainless steel, aluminum, nickel alloys, or the like. In some examples, bracket 250 may be coupled to the blade body using brazing, welding, soldering, and/or any other suitable method for attaching two metals.

### C. Illustrative Auger Assembly

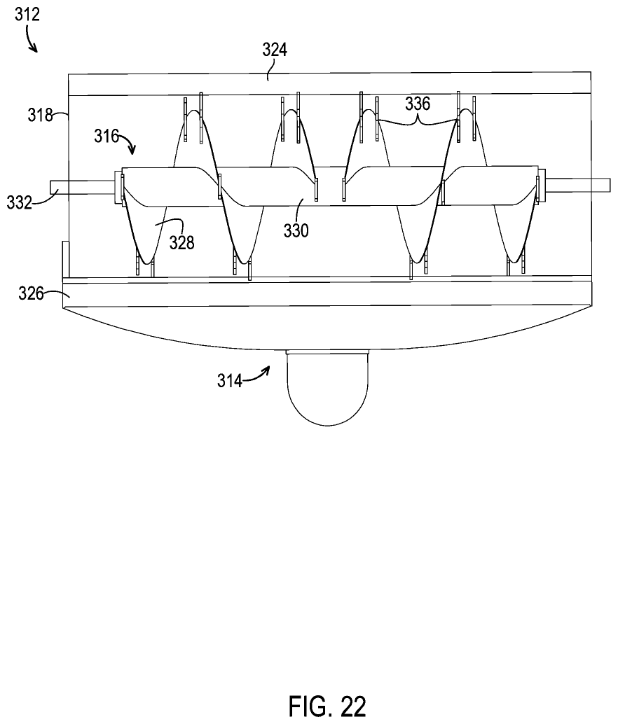

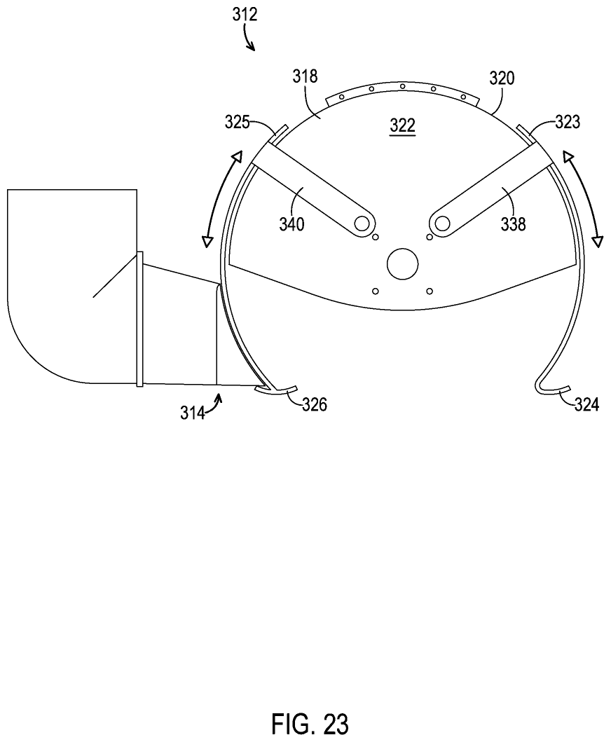

As shown in FIGS. 22 and 23, this section describes an illustrative auger assembly 312. Auger assembly 312 is an example of the auger assembly described above. Auger assembly 312 is configured to be utilized by the roof removal machine(s) described above, for example, roof removal machine 100 and/or roof removal machine 200, e.g., in place of auger assembly 112 or auger assembly 212, respectively.

As shown in FIG. 22, auger assembly 312 includes an auger 316, a blade housing 318 configured to contain removed roofing material, and an extraction port 314. In the example shown in FIG. 22, extraction port 314 is disposed along the entire rear portion of blade housing 318.

Auger 316 includes an auger flight 328 coupled to a central tube or sleeve 330. Auger flight 328 may wrap around central tube 330 in a helical fashion. Auger flight 328 may be coupled to central tube 330 using any suitable method for attaching two metals, such as welding, soldering, brazing, and/or the like. Central tube 330 is configured to receive a shaft or axle 332. Central tube 330 may be keyed, screwed, and/or otherwise mechanically secured to shaft or axle 332. Central tube 330 defines an axis of rotation 334 about which auger 316 is configured to rotate. Central tube 330 may comprise steel, aluminum, and/or any material suitable for supporting auger flight 328.

Auger flight 328 comprises one or more polygonal (e.g. rectangular) sheets of any suitable material configured to be strong and durable, such as abrasion-resistant steel, carbon steel, stainless steel, aluminum, nickel alloys, and/or the like. In the example depicted in FIGS. 22 and 23, auger 316 includes two auger flights 328A and 328B. In the current example, auger flight 328A is right-handed and auger flight 328B is left-handed. In this manner, rotating auger 316 moves removed roofing material towards the center of the auger assembly.

Auger 316 further includes a plurality of blades 336, removably coupled to edges of auger flights 328. In some embodiments, blades 336 may include one or more fastener holes 355 configured to receive fasteners (e.g. screws, pins, etc.). Auger flights 328 may include similar holes configured to receive fasteners received within fastener holes 355 of mounting brackets 350. In some embodiments, blade assemblies 336 may be permanently coupled to auger flights 328, e.g. by welding, soldering, or brazing. Blades 336 are arranged and spaced out along outer edges of the auger flights such that they impact overlapping areas of the roofing material in response to rotation of auger 316.

In some embodiments, blade assemblies are spaced such that each blade assembly is separated from adjacent blade assemblies by a separation angle of 90°, when viewed from a viewpoint perpendicular to the axis of rotation of the auger assembly. In these embodiments, blade assemblies align to form one or more colinear cutting edges, separated by 90° angles. In some embodiments, blade assemblies are separated by angles of 30°, 45°, 60°, 120°, 180°, or any other suitable angle for ensuring complete roof coverage. In some embodiments, blade assemblies may not align to form colinear cutting edges.

As shown in FIG. 23, blade housing 318 includes a top guard panel 320, first and second containment panels 322, front articulating panel 323, and rear articulating panel 325. The first and second containment panels 322 may comprise chain-link or woven fencing, mesh, or any semi-porous durable barrier material configured to ensure that roofing material removed by the removable auger assembly is contained by the blade housing. The curved guard panel 320 is coupled to extraction port 314 disposed at a center location on the guard panel and adjacent a rear edge of the guard panel. Extraction port 314 may include a round aperture coupled to a protruding nozzle or funnel. Blade housing 318 additionally comprises a front foot 324 disposed at a bottom edge of front articulating panel 323 and a rear foot 326 disposed at a bottom edge of rear articulating panel 325.

Front foot 324 may comprise any metallic material configured to be strong and durable, such as abrasion-resistant steel, carbon steel, stainless steel, aluminum, nickel alloys, or the like. Front foot 324 and rear foot 326 may be configured to curve generally upwards to enable a smooth translation of auger assembly 312 across a rough roof decking.

Front and rear articulating panels 323, 325, are rotatably coupled to first and second containment panels 322 by pivotable members 338 and 340, respectively. This enables the front and rear articulating panels to move in generally upwards and downward directions as indicated by the arrows in FIG. 23. In some examples, pivotable members 338, 340 are biased in a generally downward direction, e.g., with springs, flexible members, or another suitable biasing device. In some examples, pivotable members 338, 340 comprise a spring return.

Front and rear articulating panels 323, 325 are configured to absorb the impact of an uneven roof decking as the auger assembly is translated across the roof decking. In this manner, the front and rear articulating panels enable auger assembly 312 to translate across an uneven roof decking while maintaining a consistent cutting depth into the roofing material.

### D. Illustrative Method for Removing Roofing Material

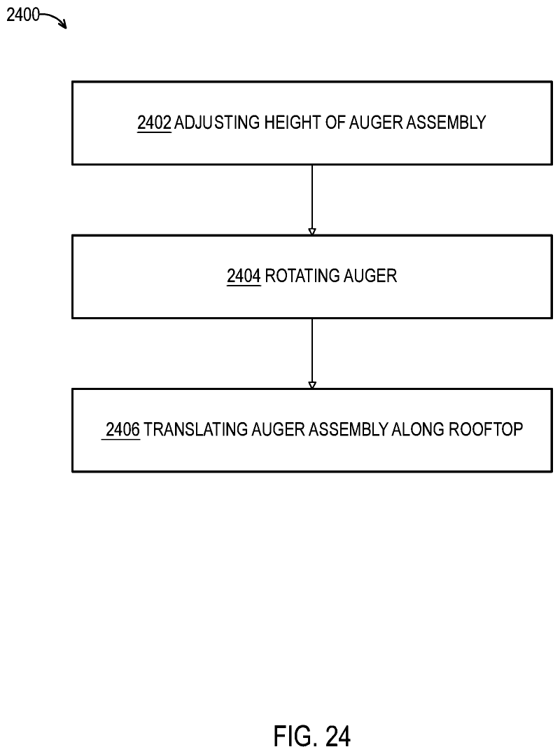

This section describes steps of an illustrative method 2400 for removing layers of roofing material from an underlying roof decking surface; see FIG. 24. Aspects of the illustrative roof removal machine(s) and the illustrative auger assembly described above may be utilized in the method steps described below. Where appropriate, reference may be made to components and systems that may be used in carrying out each step. These references are for illustration, and are not intended to limit the possible ways of carrying out any particular step of the method.

FIG. 24 is a flowchart illustrating steps performed in an illustrative method, and may not recite the complete process or all steps of the method. Although various steps of method 2400 are described below and depicted in FIG. 24, the steps need not necessarily all be performed, and in some cases may be performed simultaneously or in a different order than the order shown.

Step 2402 of method 2400 includes adjusting the cutting depth of an assembly or machine including the assembly, which is configured to slice and peel layers of roofing material from an underlying roof decking surface, for example auger assembly 112, 212, or 312. The assembly or machine includes a rotatable auger having a plurality of blades or blade assemblies removably coupled to edges of flights of the auger. The auger may include a flight radius corresponding to a desired cutting depth. In some examples, the blades are substantially L-shaped, such that the blades have both a cutting edge which slices the layers of roofing material and a peeling surface, which removes sliced layers of roofing material. In some embodiments, the blade assemblies may extend radially from the auger flight edges, extending the cutting depth of the auger.

In some embodiments, the assembly or machine may by coupled to a roof removal machine configured to power a motor, which may rotate the rotatable auger. This machine or assembly may be the illustrative auger assembly described above, the roof removal assembly described above, or any other suitable apparatus or system for removing multiple layers of roofing material.

Adjusting the height of the assembly may include lifting or lowering the auger assembly to a predetermined height corresponding to a thickness of the roofing material to be removed. The illustrative auger assembly disclosed above is configured to remove up to 6″ in depth of roofing material, but alternative auger assemblies may be capable of removing greater amounts of roofing material. Adjusting the height of the auger assembly may be facilitated with the use of a hydraulic cylinder system, which may lift or lower the auger assembly as a function of user inputs into a control system associated with the hydraulic cylinder. Adjusting the height of the auger assembly may further include lowering the auger assembly until a shearing or scraping edge of a blade guard coupled to the auger assembly or to a roof removal machine including the auger assembly contacts a top surface of roofing material to be removed.

Step 2404 of method 2400 includes powering a rotation of the auger. Rotating the auger may include rotating a shaft or axle received within a central tube of the auger. Rotating the auger may include powering a motor coupled to the assembly such that the blades of the auger slice into the roof decking. Rotating the auger may further cause the blades to slide beneath layers of roofing material and peel the material from the underlying roof decking. In some embodiments, the motor may be coupled to a shaft received within the auger assembly. In some embodiments, the motor may be directly coupled to the auger assembly.

Rotating the auger may include rotating in a first direction of rotation or in a second direction of rotation. Rotating the auger in the first direction of rotation may cause the blades of the assembly to impact the roofing material at a first angle, which may be configured to produce a deeper cutting depth. Rotating the auger in the second direction of rotation may cause the blades of the assembly to impact the roofing material at a second angle, which may produce a shallower cutting depth.

An optional step 2406 may include translating the auger assembly along a lateral direction parallel to the underlying roof decking surface. A roof removal machine including the auger assembly may include a plurality of wheels, which may aid in movement of the auger assembly along the roof's surface. In some embodiments, the roof removal machine includes a motor coupled to the wheels. In this embodiment, translating the auger assembly along the roof's surface includes powering the motor. Translating the auger assembly along the roof's surface causes the auger assembly to remove roofing material along the path of the machine.

Steps of method 2400 may be repeated as needed to remove a desired thickness of roofing material from an underlying roof decking.

### E. Illustrative Combinations and Additional Examples

This section describes additional aspects and features of roof removal systems and auger assemblies, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An auger assembly for removing layers of roofing material from an underlying roof deck, the auger assembly comprising:
a central tube defining an axis of rotation;
a first helical auger flight coaxially mounted to the central tube, such that the first helical auger flight is rotatable about the axis of rotation in first and second directions of rotation;
a plurality of L-shaped blades coupled to an outer edge of the auger flight, each blade comprising a blade edge coupled to a blade body;
wherein each of the blade edges extends in the first direction of rotation.

A1. The auger assembly of paragraph A0, wherein the L-shaped blades are evenly spaced apart by a predetermined angle.

A2. The auger assembly of paragraph A1, wherein the predetermined angle is 90°.

A3. The auger assembly of paragraph A0, wherein the blade edge comprises a durable alloy.

A4. The auger assembly of any of paragraphs A0 through A3, wherein the blade body includes a blade tip and a blade support.

A5. The auger assembly of paragraph A4, wherein the blade tip extends in a transverse direction with respect to the blade support.

A6. The auger assembly of paragraph A4, wherein the blade tip is perpendicular to the blade support.

A7. The auger assembly of any of paragraphs A0 through A6, further comprising a second auger flight coaxially mounted to the central tube.

A8. The auger assembly of any of paragraphs A0 through A7, wherein the first auger flight wraps around the central tube in a right-handed fashion.

A9. The auger assembly of paragraph A7, wherein the first auger flight wraps around the central tube in a right-handed fashion and the second auger flight wraps around the central tube in a left-handed fashion.

A10. The auger assembly of any of paragraphs A0 through A9, wherein each L-shaped blade further comprises a mounting bracket.

A11. The auger assembly of any of paragraphs A0 through A10, wherein each L-shaped blade is coupled to the auger flight by one or more pins.

B0. A roof removal machine for removing layers of roofing material from an underlying roof decking, the machine comprising:
an auger assembly including a central tube defining a central axis, a helical auger flight coaxially mounted to the central tube, and a plurality of L-shaped blades coupled to outer edges of the auger flight, each blade comprising a blade edge coupled to a blade body; and
a motor coupled to the auger assembly and configured to rotate the auger assembly about the central axis in a first direction of rotation and in a second axis of rotation;
wherein each of the blade edges extends in the first direction of rotation; and
wherein the motor is configured to rotate the auger assembly about the central axis.

B1. The roof removal machine of paragraph B0, wherein the motor is a hydraulic motor.

B2. The roof removal machine of paragraph B1, further including a gas motor powering the hydraulic motor.

B3. The roof removal machine of any of paragraphs B0 through B2, further comprising a blade housing including a blade guard and an extraction port.

B4. The roof removal machine of paragraph B3, further comprising an extraction system coupled to the extraction port.

B5. The roof removal machine of paragraph B4, wherein the extraction system comprises a vacuum system.

B6. The roof removal machine of any of paragraphs B0 through B5, further comprising a hydraulic cylinder coupled to the auger assembly, wherein the hydraulic cylinder is configured to transition the auger assembly between a plurality of heights.

B7. The roof removal machine of paragraph B3, wherein the blade guard has a front edge and a rear edge and wherein the front edge is disposed at a height higher than the rear edge corresponding to a desired cutting depth.

B8. The roof removal machine of paragraph B3, wherein the blade guard includes feet configured to maintain the plurality of L-shaped blades at a specified height range.

C0. A method for removing layers of roofing material from an underlying roof decking, the method comprising:
adjusting a height of an auger assembly including cutting and slicing blades, wherein the auger assembly is configured to remove layers of roofing material to achieve a desired cutting depth;
powering a rotation of the auger assembly such that the cutting and slicing blades impact the roofing material to the desired cutting depth.

C1. The method of paragraph C0, wherein the method further comprises translating auger assembly along a linear direction parallel to the underlying roof decking.

D0. An auger assembly for removing layers of roofing material from an underlying roof deck, the auger assembly comprising:
a central tube defining an axis of rotation;
a first helical auger flight coaxially mounted to the central tube, such that the first helical auger flight is rotatable about the axis of rotation in first and second directions of rotation;
a plurality of blades coupled to an outer edge of the auger flight, each blade comprising a blade edge coupled to a blade body;
wherein each of the blade edges extends in the first direction of rotation.

D1. The auger assembly of paragraph D0, wherein the blades are evenly spaced apart by a predetermined angle.

D2. The auger assembly of paragraph D1, wherein the predetermined angle is 90°.

D3. The auger assembly of any of paragraphs D0 through D2, wherein the blade edge comprises a durable alloy.

D4. The auger assembly of any of paragraphs D0 through D3, further comprising a second auger flight coaxially mounted to the central tube.

D5. The auger assembly of any of paragraph D0 through D4, wherein the first auger flight wraps around the central tube in a right-handed fashion.

D6. The auger assembly of paragraph D4, wherein the first auger flight wraps around the central tube in a right-handed fashion and the second auger flight wraps around the central tube in a left-handed fashion.

D7. The auger assembly of any of paragraphs D0 through D6, wherein each L-shaped blade is coupled to the auger flight by one or more pins.

E0. A roof removal machine for removing layers of roofing material from an underlying roof decking, the machine comprising:
an auger assembly including a central tube defining a central axis, a helical auger flight coaxially mounted to the central tube, and a plurality of blades coupled to outer edges of the auger flight, each blade comprising a blade edge coupled to a blade body; and
a motor coupled to the auger assembly and configured to rotate the auger assembly about the central axis in a first direction of rotation and in a second direction of rotation;
wherein each of the blade edges extends in the first direction of rotation; and
wherein the motor is configured to rotate the auger assembly about the central axis.

E1. The roof removal machine of paragraph E0, wherein the motor is a hydraulic motor.

E2. The roof removal machine of paragraph E1, further including a gas motor powering the hydraulic motor.

E3. The roof removal machine of any of paragraphs E0 through E2, further comprising a blade housing including a blade guard and an extraction port.

E4. The roof removal machine of any of paragraphs E3 through E3, further comprising an extraction system coupled to the extraction port.

E5. The roof removal machine of paragraph E4, wherein the extraction system comprises a vacuum system.

E6. The roof removal machine of any of paragraphs E0 through E5, further comprising a hydraulic cylinder coupled to the auger assembly, wherein the hydraulic cylinder is configured to transition the auger assembly between a plurality of heights.

E7. The roof removal machine of paragraph E3, wherein the blade guard has a front edge and a rear edge and wherein the front edge is disposed at a height higher than the rear edge corresponding to a desired cutting depth.

E8. The roof removal machine of paragraph E3, wherein the blade guard includes runners configured to maintain the plurality of blades at a specified height range.

F0. A roof removal apparatus, comprising:
a vehicle configured to travel across an underlying surface; and
an auger assembly coupled to the vehicle, the auger assembly including
   a central axle defining an axis of rotation transverse to a direction of travel of the vehicle,
   a first helical auger flight having an inner edge coupled to the central axle, such that the first helical auger flight is rotatable about the axis of rotation, and
   a plurality of blades removably coupled to an outer edge of the first helical auger flight;
wherein rotation of the first helical auger flight about the axis of rotation is configured to cause the plurality of blades to cut into the underlying surface.

F1. The roof removal apparatus of paragraph F0, wherein the axle comprises a sleeve releasably fixed to a coaxial central shaft, such that the sleeve and the shaft rotate together about the axis of rotation.

F2. The roof removal apparatus of any of paragraphs F0 through F1, wherein the blades are evenly spaced apart along the outer edge of the first helical auger flight.

F3. The roof removal apparatus of any of paragraphs F0 through F2, wherein the blades are spaced apart at 90° intervals.

F4. The roof removal apparatus of any of paragraphs F0 through F3, further comprising a second helical auger flight coupled to the central axle.

F5. The roof removal apparatus of any of paragraphs F0 through F4, wherein the first helical auger flight wraps around the central axle in a right-handed fashion and the second helical auger flight wraps around the central axle in a left-handed fashion.

F6. The roof removal apparatus of any of paragraphs F0 through F5, wherein each blade is coupled to the first helical auger flight by one or more pins.

F7. The roof removal apparatus of any of paragraphs F0 through F6, wherein each blade has a cutting edge oriented transverse to a direction of rotation of the first helical auger flight.

F8. The roof removal apparatus of any of paragraphs F0 through F7, wherein at least one blade has an L-shaped profile and a cutting edge oriented orthogonal to a direction of rotation of the first helical auger flight.

F8.1 The roof removal apparatus of any of paragraphs F0 through F8, wherein at least one blade has a J-shaped profile and a cutting edge oriented in a plane that is orthogonal to the axis of rotation.

F9. The roof removal apparatus of any of paragraphs F0 through F8.1, further comprising a guard partially surrounding the first helical auger flight and the blades, such that the first helical auger flight and the blades are configured to remain exposed to the underlying surface.

F10. The roof removal apparatus of paragraph F9, wherein a lower front edge of the guard and a lower rear edge of the guard are configured to contact the underlying surface during operation, and the guard is adjustable to produce a selected offset between a lower front edge height and a lower rear edge height.

F11. The roof removal apparatus of paragraph F10, wherein the lower front edge of the guard includes at least one runner configured to ride across the underlying surface.

G0. A roof removal machine, comprising:
an auger assembly including a central axle defining an axis of rotation, a first helical auger flight coupled to the central axle, and a plurality of blades coupled to an outer edge of the first helical auger flight, each blade comprising a blade edge and a blade body; and
a motor operably coupled to the auger assembly and configured to rotate the auger assembly about the axis of rotation in at least a first direction of rotation;
wherein the blade edge of each of the blades is oriented transverse to the first direction of rotation.

G1. The roof removal machine of paragraph G0, further comprising a guard partially surrounding the auger assembly, wherein the first helical auger flight is configured to direct material captured by the auger assembly toward an extraction port in the guard.

G2. The roof removal machine of paragraph G1, wherein the guard has a front edge and a rear edge and wherein the front edge is disposed at a height higher than the rear edge, such that a resulting height differential corresponds to a selected cutting depth.

G3. The roof removal machine of either of paragraphs G1 or G2, further comprising a debris extraction system coupled to the extraction port, wherein the debris extraction system comprises a vacuum extraction tube.

G4. The roof removal machine of any of paragraphs G1 through G3, wherein the guard further comprises one or more runners configured to ride across an underlying roof surface.

G5. The roof removal machine of any of paragraphs G1 through G4, wherein the extraction port is disposed at a transverse midpoint of the guard.

G6. The roof removal machine of any of paragraphs G0 through G5, further comprising a hydraulic cylinder coupled to the auger assembly, wherein the hydraulic cylinder is configured to selectively transition the auger assembly between a plurality of heights.

G7. The roof removal machine of any of paragraphs G0 through G6, wherein each blade is coupled to the first helical auger flight by one or more removable fasteners.

### Advantages, Features, and Benefits

The different embodiments and examples of the multifunctional auger described herein provide several advantages over known solutions for roof removal. For example, illustrative embodiments and examples described herein allow for cutting and peeling of an existing flat roof with a single apparatus. The ability of a single apparatus to perform a variety of roof removal functions reduces the number of workers required to complete a reroofing project, and may result in shorter project completion times.

Additionally, and among other benefits, illustrative embodiments and examples described herein produce smaller pieces of roofing debris than previous methods, which produce large strips and sheets of roofing material. Large strips of roofing material are difficult to remove from the rooftop, and may require a large number of trucks and a high amount of landfill space. Smaller pieces of debris may be removed from the rooftop using a vacuum system, and may require less space in transportation and in disposal due to higher packing efficiency. This reduction in transportation needs may have environmental benefits.

Additionally, and among other benefits, illustrative embodiments and examples described herein transport roofing debris from a rooftop to a refuse collection area beneath the rooftop. This benefit reduces hazards to workers, as existing reroofing processes require workers to toss or throw roofing debris from the edge of the rooftop, increasing fall risk. Using a vacuum system to transport debris may also decrease the amount of particulate matter released into the surrounding environment, providing safer conditions for workers and for bystanders.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A roof removal apparatus, comprising:
a vehicle configured to travel across an underlying surface; and
an auger assembly coupled to the vehicle, the auger assembly including
a central axle defining an axis of rotation transverse to a direction of travel of the vehicle,
a first helical auger flight having an inner edge coupled to the central axle, such that the first helical auger flight is rotatable about the axis of rotation, and
a plurality of blades removably coupled to an outer edge of the first helical auger flight;
wherein rotation of the first helical auger flight about the axis of rotation is configured to cause the plurality of blades to cut into the underlying surface.

2. The roof removal apparatus of claim 1, wherein the axle comprises a sleeve releasably fixed to a coaxial central shaft, such that the sleeve and the shaft rotate together about the axis of rotation.

3. The roof removal apparatus of claim 1, wherein the blades are evenly spaced apart along the outer edge of the first helical auger flight.

4. The roof removal apparatus of claim 2, wherein the blades are spaced apart at 90° intervals.

5. The roof removal apparatus of claim 1, further comprising a second helical auger flight coupled to the central axle.

6. The roof removal apparatus of claim 5, wherein the first helical auger flight wraps around the central axle in a right-handed fashion and the second helical auger flight wraps around the central axle in a left-handed fashion.

7. The roof removal apparatus of claim 1, wherein each blade is coupled to the first helical auger flight by one or more pins.

8. The roof removal apparatus of claim 1, wherein each blade has a cutting edge oriented transverse to a direction of rotation of the first helical auger flight.

9. The roof removal apparatus of claim 1, wherein at least one blade has a curvilinear back profile and a cutting edge oriented in a plane orthogonal to the axis of rotation.

10. The roof removal apparatus of claim 1, further comprising a guard partially surrounding the first helical auger flight and the blades, such that the first helical auger flight and the blades are configured to remain exposed to the underlying surface.

11. The roof removal apparatus of claim 10, wherein a lower front edge of the guard and a lower rear edge of the guard are configured to contact the underlying surface during operation, and the guard is adjustable to produce a selected offset between a lower front edge height and a lower rear edge height.

12. The roof removal apparatus of claim 11, wherein the lower front edge of the guard includes at least one runner configured to ride across the underlying surface.

13. A roof removal machine, comprising:
an auger assembly including a central axle defining an axis of rotation, a first helical auger flight coupled to the central axle, and a plurality of blades coupled to an outer edge of the first helical auger flight, each blade comprising a blade edge and a blade body; and
a motor operably coupled to the auger assembly and configured to rotate the auger assembly about the axis of rotation in at least a first direction of rotation;
wherein the blade edge of each of the blades is oriented transverse to the first direction of rotation.

14. The roof removal machine of claim 13, further comprising a guard partially surrounding the auger assembly, wherein the first helical auger flight is configured to direct material captured by the auger assembly toward an extraction port in the guard.

15. The roof removal machine of claim 14, wherein the guard has a front edge and a rear edge and wherein the front edge is disposed at a height higher than the rear edge, such that a resulting height differential corresponds to a selected cutting depth.

16. The roof removal machine of claim 14, further comprising a debris extraction system coupled to the extraction port, wherein the debris extraction system comprises a vacuum extraction tube.

17. The roof removal machine of claim 14, wherein the guard further comprises one or more runners configured to ride across an underlying roof surface.

18. The roof removal machine of claim 14, wherein the extraction port is disposed at a transverse midpoint of the guard.

19. The roof removal machine of claim 13, further comprising a hydraulic cylinder coupled to the auger assembly, wherein the hydraulic cylinder is configured to selectively transition the auger assembly between a plurality of heights.

20. The roof removal machine of claim 13, wherein each blade is coupled to the first helical auger flight by one or more removable fasteners.
